(19) United States
(12) Patent Application Publication
(10) Pub. No.: US 2024/0268001 A1
(43) Pub. Date: Aug. 8, 2024

(54) ELECTROMAGNETIC INDUCTION CAN CURING OVEN

(71) Applicant: Stolle Machinery Company, LLC, Centennial, CO (US)

(72) Inventors: Stephen D. Christensen, Highlands Ranch, CO (US); John Nigel Grainger, West Yorkshire (GB)

(73) Assignee: Stolle Machinery Company, LLC, Centennial, CO (US)

(21) Appl. No.: 18/105,938

(22) Filed: Feb. 6, 2023

(51) Int. Cl. H05B 6/10; B05D 3/02; H05B 6/44

(52) U.S. Cl. CPC H05B 6/103; B05D 3/0272; H05B 6/44

(57) ABSTRACT

A can curing oven for curing one or more coatings on one or more surfaces of a sidewall of a number of can bodies includes a heating assembly having a number of induction heating units that define a space generally enclosed by the number of induction heating units. Each induction heating unit capable of producing a total effective amount of received heat needed to cure the coating on each can body. The curing oven further includes a conveyance arrangement for supporting and moving a number of can bodies along a workpath through the generally enclosed space among the number of induction heating units.

### FIELD OF THE INVENTION

The disclosed concept relates to arrangements for curing coatings on surfaces of can bodies and, more particularly, to arrangements for curing coatings that utilize electromagnetic induction for creating the heat used for such curing.

### BACKGROUND OF THE INVENTION

Pin ovens are well known in the art and are widely used in the industry for drying/curing the coating on the exterior of partially completed, open-ended beverage cans (also referred to herein as “can bodies”). A can decorator applies the coating to the exterior of the cans. The coating includes, but is not limited to, ink, enamel used to apply the label, an overcoat of lacquer or varnish, or both a printed label and overcoat. Such ovens include a number of heaters, typically natural gas heaters, that generate a heated fluid (air). That is, natural gas is burned thereby heating the air. The heated air is generally maintained in a heated, enclosed space through which a conveyor chain follows a generally vertical serpentine path. As such, pin ovens occupy a large volume and have a complex motion assembly. That is, in order for the conveyor chain to have a path of sufficient length to allow the cans to cure, the enclosed space typically has a volume of about 75 m³. This is a problem as such ovens occupy a large space within a processing facility. Further, a conveyor that extends over a serpentine path requires complex mechanical assemblies to accommodate the change in direction of the conveyor.

The conveyor chain supports the cans on a number of pins. That is, elongated carrier pins are attached to the conveyor chain in spaced relation along its entire length. The open-ended cans are placed onto the extended pins and are carried over a serpentine chain path through the oven. Nozzles aligned with the chain path direct heated air against the outsides of the cans as they travel through the oven enclosed space. The heated air both maintains the cans on the pins and cures the coating. As the heated air streams are structured to hold, and stabilize, the cans on the pins, most pin ovens continuously direct heated air against the can bottoms. Generally, however, the can bottoms do not have a coating applied thereto. As such, energy is lost or wasted when the heated air is directed against the can bottoms.

Pin ovens are operated at a temperature of about 420° F. and are structured to, and do, operate substantially continuously. As such, the pin ovens are not structured to quickly cool down or quickly heat up. In this configuration, operators typically leave the pin oven heaters in operation even if the pin ovens are not in use. That is, for example, if the flow of cans being processed is interrupted due to a problem or routine maintenance on another machine in the can processing line, the pin oven heaters are operated so as to prevent the pin oven from cooling down. That is, rather than allowing the pin oven heaters to cease operation causing the pin oven to cool below operating temperatures, operators keep the pin oven heaters in operation. As such, energy is wasted due to the inability of the pin oven to heat up quickly.

Pin ovens further use fans to move the heated air and to vent the exhaust. With both natural gas heaters and exhaust fans in operation, pin ovens are loud, typically operating at about 95 dB. This is a problem as well. Further, energy consumption, both in terms of natural gas used to fuel the heaters and electricity to operate the exhaust fans, is substantial. Energy cost savings are, therefore, extremely important. Further, pin ovens as described above have reached the practical limits of can drying speeds and capacities. Presently, pin ovens process about 2400 cans per minute (cpm). Other can processing machines such as, but not limited to, the decorators, have exceeded this speed. Thus, the pin ovens are a bottleneck in the can processing line.

There is, therefore, a need for an improved can curing oven.

### SUMMARY OF THE INVENTION

These needs, and others, are met by at least one embodiment of the disclosed and claimed concept which provides a can curing oven structured to cure a coating on a surface of a sidewall of a number of can bodies. The can curing oven comprises: a heating assembly including a number of induction heating units sized and configured to define a space generally enclosed by the number of induction heating units, the number of induction heating units structured to generate a total effective amount of received heat needed to cure the coating on each can body; and a conveyance arrangement structured to support and move a number of can bodies along a workpath through the generally enclosed space.

Each induction heating unit may comprise: a heating element; and an induction coil positioned around the heating element, the induction coil structured to be coupled to a controlled source of AC power.

The heating element may comprise a length of c-channel.

The number of induction heating units may include a plurality of induction heating units; and at least two induction heating units of the plurality of induction heating units may be disposed on opposing sides of the workpath.

The number of induction heating units may include a plurality of induction heating units; and at least two induction heating units of the plurality of induction heating units may be disposed on a single side of the workpath.

The can curing oven may further comprise a housing generally enclosing the heating assembly.

The can curing oven may be structured to cure a coating of a can body in a first configuration and a can body in a second configuration wherein a can body of the first configuration is different than a can body of the second configuration, and wherein: the housing assembly includes an adjustable mounting assembly; and the adjustable mounting assembly is structured to position each induction heating unit in: a first position, wherein each induction heating unit is structured to generate a proportional effective amount of received heat for a can body of a first configuration, and a second position, wherein each induction heating unit is structured to generate a proportional effective amount of received heat for a can body of a second configuration.

Each induction heating unit may be a modular induction heating unit.

Each induction coil may be structured to be selectively powered by the controlled source of AC power when the outer surface of the can body is an effective distance away.

The conveyance arrangement may include a plurality of support elements; and each support element of the plurality of support elements may be structured to be coupled to, and support a can body.

At least one induction heating unit of the number of induction heating units may be positioned between two different portions of the workpath or between a portion of the workpath and a portion of another workpath along which the conveyance arrangement and/or another conveyance arrangement is structured to move can bodies of the number of can bodies.

The number of heating units may be structured to process can bodies at a maximum can decorator speed.

The conveyance arrangement may be structured to support and move the number of can bodies along a linear workpath through the generally enclosed space.

The conveyance arrangement may be structured to support and move the number of can bodies along a non-linear workpath through the generally enclosed space.

Another embodiment of the disclosed and claimed concept provides a method of curing a coating on a surface of a sidewall of each can of a number of can bodies, the method comprises: providing the number of can bodies adjacent a number of induction heating units, and powering the number of induction heating units to generate a total effective amount of received heat needed to cure the coating on the outer surface of the sidewall of each can body of the number of can bodies.

Each induction heating unit may comprise: a heating element and an induction coil positioned around the heating element; and powering the number of induction heating units may comprise selectively providing AC power to the induction coil.

Powering the number of induction heating units to generate the total effective amount of received heat may comprise powering the number of induction heating units from an unpowered state when the outer surface of a can body of the number of can bodies is an effective distance away from an induction heating unit of the number of induction heating units.

Providing the number of can bodies adjacent the number of induction heating units may comprise providing a plurality of can bodies adjacent the number of induction heating units via a conveyance arrangement.

Powering the number of induction heating units to generate the total effective amount of received heat may comprise: powering the number of induction heating units from an unpowered state when the outer surface of a can body of the number of can bodies is an effective distance away from an induction heating unit of the number of induction heating units, and returning the number of induction heating units to the unpowered state upon the outer surface of another can body of the number of can bodies moving from an effective distance away from an induction heating unit of the number of induction heating units.

Providing the number of can bodies adjacent a number of induction heating units may comprise providing the number of can bodies along a linear workpath adjacent the number of induction heating units.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the concept.

### BRIEF DESCRIPTION OF THE DRAWINGS

A full understanding of the invention can be gained from the following description of the preferred embodiments when read in conjunction with the accompanying drawings in which:

FIG. 1 is a partially schematic perspective view of a decorator system in accordance with an example embodiment of the disclosed concept;

FIG. 2 is a partially schematic cross-sectional view of a can body in accordance with an example embodiment of the disclosed concept;

FIG. 3 is a partially schematic sectional view of a heating arrangement of the can curing oven of the decorator system of FIG. 1 as indicated at 3-3 in FIG. 1;

FIG. 4 is a partially schematic perspective view of an inductive heating unit of a heating arrangement in accordance with an example embodiment of the disclosed concept;

FIG. 5 is a partially schematic sectional view, similar to the view of FIG. 3, of a heating arrangement of a can curing oven in accordance with another example embodiment of the disclosed concept showing the heating arrangement in a first configuration; and

FIG. 6 is a partially schematic sectional view of the heating arrangement of FIG. 5 showing the heating arrangement in a second configuration.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together or act upon/with each other in some manner. For example, an automobile has four tires and four hub caps. While all the elements are coupled as part of the automobile, it is understood that each hubcap is “associated” with a specific tire.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut or threaded bore. Further, a passage in an element is part of the “coupling” or “coupling component(s).” For example, in an assembly of two wooden boards coupled together by a nut and a bolt extending through passages in both boards, the nut, the bolt and the two passages are each a “coupling” or “coupling component.”

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, a “path of travel” or “path,” when used in association with an element that moves, includes the space an element moves through when in motion. As such, any element that moves inherently has a “path of travel” or “path.” Further, a “path of travel” or “path” relates to a motion of one identifiable construct as a whole relative to another object. For example, assuming a perfectly smooth road, a rotating wheel (an identifiable construct) on an automobile generally does not move relative to the body (another object) of the automobile. That is, the wheel, as a whole, does not change its position relative to, for example, the adjacent fender. Thus, a rotating wheel does not have a “path of travel” or “path” relative to the body of the automobile. Conversely, the air inlet valve on that wheel (an identifiable construct) does have a “path of travel” or “path” relative to the body of the automobile. That is, while the wheel rotates and is in motion, the air inlet valve, as a whole, moves relative to the body of the automobile.

As used herein, the word “unitary” means a component that is created as a single piece or unit. That is, a component that includes pieces that are created separately and then coupled together as a unit is not a “unitary” component or body.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center of the cylinder. That is, generally, for a cylindrical soup can, the “radial side/surface” is the generally circular sidewall and the “axial side(s)/surface(s)” are the top and bottom of the soup can. Further, as used herein. “radially extending” means extending in a radial direction or along a radial line. That is, for example, a “radially extending” line extends from the center of the circle or cylinder toward the radial side/surface. Further, as used herein, “axially extending” means extending in the axial direction or along an axial line. That is, for example, an “axially extending” line extends from the bottom of a cylinder toward the top of the cylinder and substantially parallel to a central longitudinal axis of the cylinder.

As used herein, “generally curvilinear” includes elements having multiple curved portions, combinations of curved portions and planar portions, and a plurality of planar portions or segments disposed at angles relative to each other thereby forming a curve.

As used herein, a “planar body” or “planar member” is a generally thin element including opposed, wide, generally parallel surfaces, i.e., the planar surfaces of the planar member, as well as a thinner edge surface extending between the wide parallel surfaces. That is, as used herein, it is inherent that a “planar” element has two opposed planar surfaces. The perimeter, and therefore the edge surface, may include generally straight portions, e.g., as on a rectangular planar member, or be curved, as on a disk, or have any other shape.

As used herein, “upwardly depending” means an element that extends upwardly and generally perpendicular from another element.

As employed herein, the terms “can” and “container” are used substantially interchangeably to refer to any known or suitable container, which is structured to contain a substance (e.g., without limitation, liquid; food; any other suitable substance), and expressly includes, but is not limited to, beverage cans, such as beer and beverage cans, as well as food cans.

As used herein, a “can body” includes a base and a depending, or upwardly depending, sidewall. The “can body” is unitary. In this configuration, the “can body” defines a generally enclosed space. Thus, the “can body,” i.e., the base and sidewall, also include(s) an outer surface and an inner surface. That is, for example, a “can body” includes a sidewall inner surface and a sidewall outer surface.

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, an “elongated” element inherently includes a longitudinal axis and/or longitudinal line extending in the direction of the elongation.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

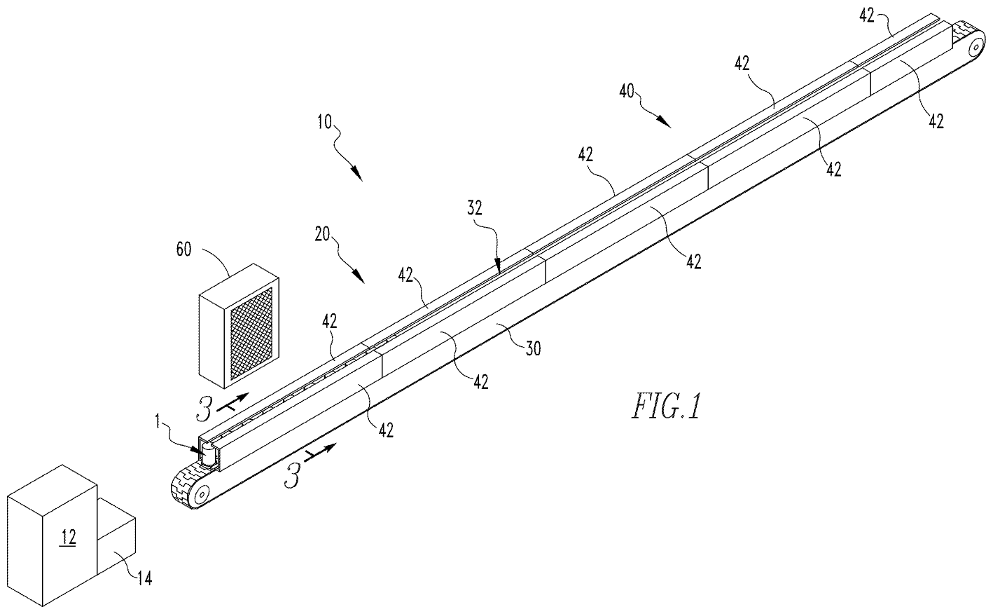

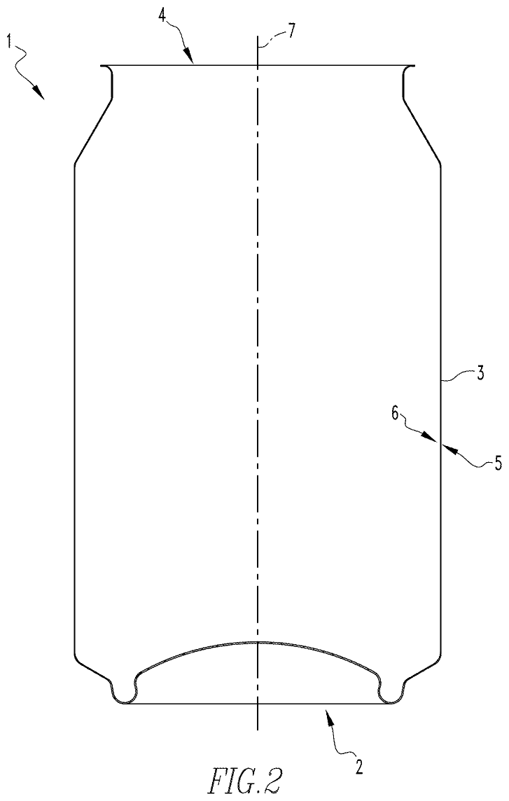

A partially schematic representation of a decorator system 10 in accordance with one example embodiment of the disclosed concept is shown in FIG. 1. The decorator system 10 is structured to, and does, apply a coating to a can body 1 and subsequently cure that coating. In an exemplary embodiment such as shown in FIG. 2, the can body 1 is generally cylindrical and includes a base 2, a sidewall 3, and a top opening 4 defined by a top portion (not numbered) of the sidewall 3 opposite the base 2. As noted above, the can body 1 has an inner surface and an outer surface; thus, the sidewall 3 of each can body 1 has an outer surface 5 and an inner surface 6. Further, the generally cylindrical can body 1 includes a longitudinal axis 7 extending centrally through the bottom 2 and the top opening 4 about which the sidewall 3 is disposed. The aforementioned coating (not shown) is typically applied to the outer surface 5 of the sidewall 3 of the can body 1 but may also be applied to the inner surface 6 depending on the particular application.

Referring again to FIG. 1, the decorator system 10 generally includes a decorator assembly 12 (shown schematically) and a can curing oven 20. As is known, the decorator assembly 12 is structured to, and does, apply a coating, or coatings, to one or more areas of the can body 1. Further, as is known, the decorator assembly 12 is structured to, and does, process over 2400 can bodies per minute (hereinafter, “cpm”). The speed of the decorator assembly in cpm is, as used herein, the “can decorator speed.” Thus, as used herein, a “maximum can decorator speed” is over 2400 cpm. As is known, the coatings that may be applied include, but are not limited to, inks, paints, varnishes, and lacquers. The decorator system 10 further includes a transfer assembly 14 (also shown schematically) provided separately from, or as a portion of, the decorator assembly 12. The transfer assembly 14 is structured to, and does, move one coated, but not yet cured, can body 1 at a time from the decorator assembly 12 to the can curing oven 20.

The can curing oven 20 includes a conveyance arrangement 30, and a heating assembly 40. A housing assembly (not shown) may encompass generally all, or select portions of, the can curing oven 20 and or decorator system 10. The conveyance arrangement 30 may be any arrangement suitable for supporting and moving a number of can bodies 1 through a space 32 generally defined/enclosed by a number of portions of the heating assembly 40 as discussed below. In the example embodiment illustrated in FIG. 1, the conveyance arrangement 30 is shown generally as a conveyor type arrangement moving a plurality of can bodies 1 along a linear workpath (as generally shown in-part by the line of can bodies 1 extending into the space 32 from the end thereof adjacent transfer arrangement 14). In an example embodiment, the conveyance arrangement 30 includes a chain with can body support pins, similar to that used in a traditional pin oven. It is to be appreciated that such examples are provided for exemplary purposes only and that the structure of the conveyance arrangement 30 and components thereof may be varied without varying form the scope of the disclosed concept. It is also to be appreciated that the conveyance arrangement 30 may be structured to move can bodies 1 along a non-linear (e.g., without limitation, curved, serpentine, etc.) workpath without varying from the scope of the disclosed concept.

In one example embodiment of the disclosed concept the can curing oven 20, and more specifically the conveyance arrangement 30 thereof, is structured to have an operating speed corresponding to the maximum can decorator speed (previously discussed). As used herein, an “operating speed” is the speed (in cpm) of the assembly in operation as opposed to a speed the assembly can achieve when not in operation. That is, for example, the conveyance arrangement 30 has a maximum operating speed wherein the conveyance arrangement 30 moves can bodies as the coating is cured. The conveyance arrangement 30 may, however, be able to move at a greater speed when not encumbered by can bodies 1. Such a non-“operating speed” is not relevant to this application. In an exemplary embodiment, the conveyance arrangement 30 moves can bodies 1 at a speed equal to the maximum can decorator speed. As will be appreciated from the further description below, embodiments of the disclosed concept provide for an overall length of the workpath within can curing oven 20 to be adjusted (e.g., lengthened) to account for higher decorator speeds.

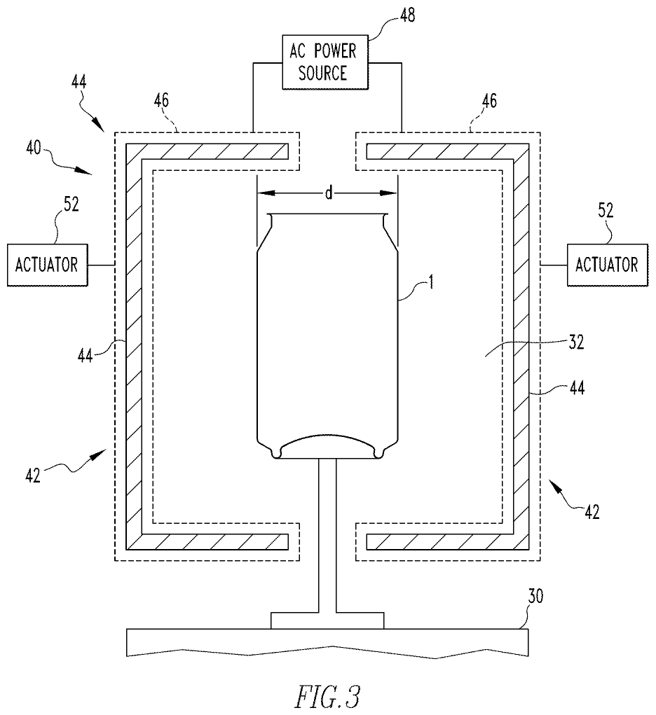

Continuing to refer to FIG. 1, as well to the sectional view of FIG. 3, the heating assembly 40 includes a number of induction heating units 42 which is/are sized and configured to generally define/enclose the space 32 through which the number of can bodies 1 are moved through via the conveyance arrangement 30. As used herein, an “induction heating unit” is an arrangement that produces heat from an element positioned within an alternating magnetic field. In the example shown in FIGS. 1 and 3, the number of induction heating units 42 is a plurality of induction heating units 42 positioned/disposed on opposing sides of the workpath along which the conveyance arrangement 30 moves the number of can bodies 1. In such arrangement, the induction heating units 42 on each side of the workpath are arranged end to end so as to provide a sufficient length to the workpath defined thereby to provide for a sufficient residence time therein to cure the coating provided on the can bodies 1 passing therethrough. As mentioned above, the heating units 42 may be of one or more different (e.g., non-linear) shapes and thus define a non-linear path and/or multi-level arrangement to fit the space needs for a particular application.

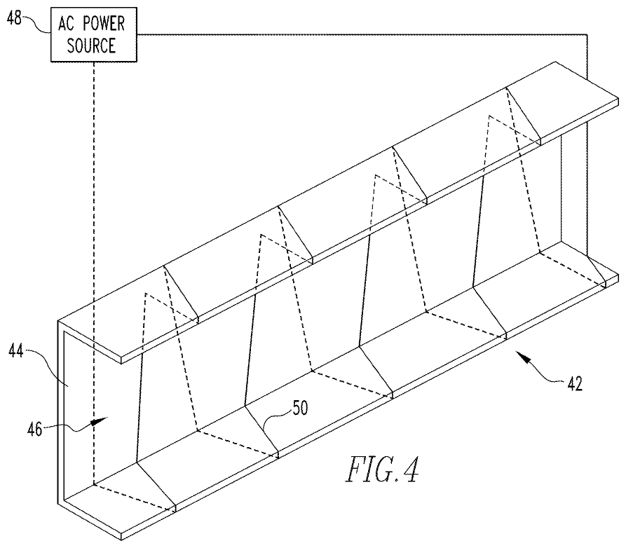

Referring now to FIG. 4 in addition to FIG. 3, each induction heating unit 42 of heating assembly 40 includes a heating element 44 that is selectively actuated, i.e., caused to radiate heat, by selectively applying an alternating magnetic field thereto. In the example shown generally schematically in FIGS. 3 and 4, the heating element 44 is an elongate c-channel member formed from a steel or other suitable material. Preferably, heating element 44 is sourced from a commercially available item (e.g., c-channel, angle, I-beam, flat bar, etc.) or formed from a bent/folded sheet-like material. In any case, heating element 44 is formed from a ferrous (or other suitable) material that when placed in alternating magnetic field has eddy currents generated therein which result in suitable heating of the heating element 44 such as described in greater detail below. In the example shown in FIGS. 3 and 4, an alternating magnetic field is applied to each heating element 44 by an induction coil 46 positioned around the heating element 44 and selectively powered by an AC power source 48. As is known, when a conductive material, i.e., the heating element 44, is placed in such alternating magnetic field, two heating effects of the material occur: hysteresis losses—these occur only in magnetic materials such as iron, nickel, cobalt, etc. due to the friction between the molecules when the material is being continuously magnetized in different directions, higher magnetic field oscillation frequency results in faster particle movement, which causes more friction and thus more heat; and eddy-current losses—these occur as a Joule heating effect in any conductive material because of the electric currents induced by the fluctuating magnetic field. The induction coil 46 is formed from one or more conductive wires 50 that are generally wound around the heating element 44 without being electrically connected to the heating element 44.

The number of induction heating units 42, are structured to, and do, generate a total effective amount of received heat. As used herein, a “total effective amount of received heat” (or “total effective amount of received radiant heat”) means heat received (or radiant heat received) at, or by, the can body 1 sufficient to cure the coating(s) thereon and not substantially more than the minimal amount required to cure the coating on the can body 1. Thus, after each can body 1 of the number of can bodies 1 moves through the heating assembly 40 of the can curing oven 20, the coating thereon is cured and each can body 1 is ready for further processing. As used herein, “received heat” (or “received radiant heat”) means the energy (or radiant energy) received at, or by, the can body 1. It is understood that “received heat” is dependent upon a number of variables including, but not limited to, the energy output of the heating assembly 40, the distance between each induction heating unit 42 of the number of induction heating units 42 and the can bodies 1 as the can bodies 1 pass by, and the duration, i.e., the amount of time, the can bodies 1 are exposed to the heat and/or the heating units 42. It is understood that those of ordinary skill in the art would readily understand/know how to adjust such variables to determine a desirable configuration of the can curing oven 20.

As discussed below, in one exemplary embodiment the can curing oven 20 is optimized for speed (as measured in cpm). Further, the can curing oven 20 is, in other embodiments, also optimized for size, energy efficiency, and/or economic efficiency. Each configuration requires the optimization of multiple variables. Further, a single induction heating unit 42, is structured to, and does, generate a “proportional effective amount of received heat.” As used herein, a “proportional effective amount of received heat” means a portion of the “total effective amount of received heat” generated by a single induction heating unit 42 of the heating assembly 40. The number of induction heating units 42 are structured to, and do, generate a total effective amount of received radiant heat. That is, the radiant heat generated by the number of induction heating units 42 is sufficient to cure the coating on the can body 1.

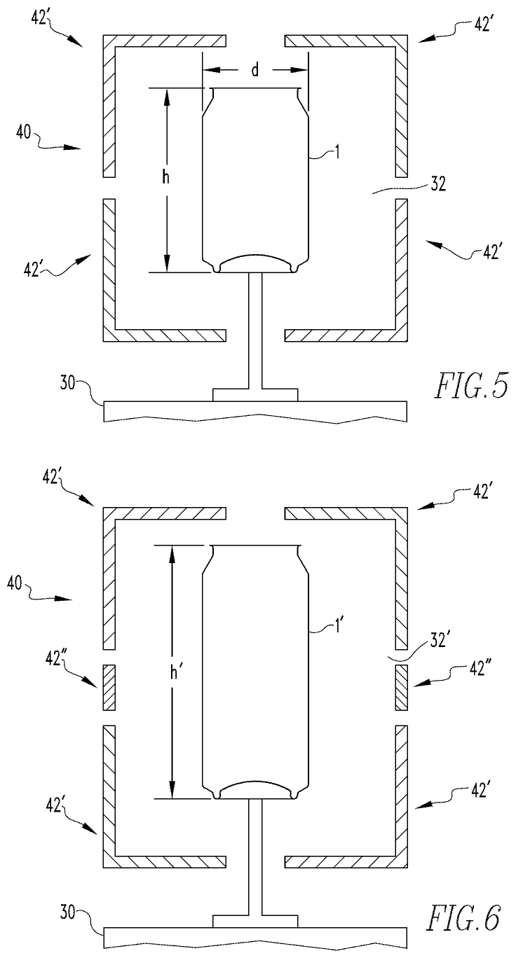

In example embodiments of the disclosed concept the induction heating units 42 may be modular heating units. In other words, induction heating units 42 may be added, removed, or repositioned either manually or via a suitable automatic or semi-automatic arrangement to adjust from handling curing operations of a can body 1 of a first configuration to a particular can body 1′ of a second configuration. For example, as shown in the example arrangement of FIG. 3, one or more actuators 52 or adjustable mounting assemblies may be provided to selectively adjust the spacing between the induction heating elements 42 so as to provide for can bodies 1 of different diameters d to be processed therethrough. Meanwhile, FIGS. 5 and 6 show an example embodiment of a heating assembly 40′ which employs induction heating units 42′ and 42″ which operate similar to induction heating units 42 but that allow for can bodies 1, l′ of different heights h, h′ (and/or of different diameters) to be processed therethrough. For example, to go from the first configuration of FIG. 5 to the second potential configuration of FIG. 6, the upper pair of induction heating units 42′ shown are moved vertically upward (with respect to the arrangement shown in the Figures) and the additional induction heating units 42″ are positioned vertically between the upper and lower pairs of induction heating units 42′ to arrive at the arrangement shown in FIG. 6. Additionally, such arrangement of induction heating units 42′ and 42″ could be adjusted similar to that of FIG. 3 to also provide for can bodies of different diameters d. It is to be appreciated that such positionings/repositionings of induction heating units may be accomplished either manually or via a number of suitable actuators 52 or other suitable arrangement(s) without varying from the scope of the disclosed concept.

As the heating element 44 of each heating unit 42 radiates heat completely thereabout and not just from a single side or sides, it is to be appreciated that in some example embodiments a number of heating units 42 may be employed to heat can bodies 1 passing on more than one side thereof (e.g., can bodies 1 moving along parallel workpaths with a heating unit 42 or string thereof positioned therebetween). In embodiments where such generally omnidirectional radiant heat is not desired, coating(s) or shielding may be employed to limit heat from heating element 44 in undesired directions.

In one embodiment, induction heating units 42 are structured to become fully active within a few minutes. As used herein, “fully active” means to become hot enough to cure the coating applied to the can body. That is, unlike a heated air convection oven, which must heat the air in a larger enclosed space therein, the induction heating units 42 as described positioned in close proximity to the can bodies 1 can begin heating the can bodies 1 much faster. This solves problems noted above. Further, an induction heating unit 42 generates less noise than a heated air convection oven. In an exemplary embodiment, a can curing oven 20 without a fan generates between about 10 dB and 20 dB, or about 15 dB. As used herein, a noise level of between about 10 dB and 20 dB is a “reduced amount of noise.” As used herein, a noise level of about 15 dB is a “specific reduced amount of noise.” A can curing oven 20 generates a reduced amount of noise, or a specific reduced amount of noise, solving the problem(s) stated above. Further, when a can curing oven 20 as described above utilizes a fan, the curing oven 20 generates between about 70 dB and 80 dB, or about 75 dB, which is still less noise than the prior art curing ovens and also solves the problem(s) stated above.

In one embodiment, the can curing oven 20 is optimized for speed. That is, as noted above, it is desirable for the curing oven to have an intake speed that is equivalent to the output speed of the decorator assembly 12. In an exemplary embodiment, the output speed of the decorator assembly 12, and therefore the intake speed of the can curing oven 20, is about 2400 cpm. Further, as noted above, other variables that affect the curing of a coating on a can body 1 include, but are not limited to, the energy output of the heating assembly 40, the distance between the induction heating units 42 and the can bodies 1, and the duration the can bodies 1 are exposed to the heat and/or the induction heating units 42. Further, the size of the enclosed space 32, is also dependent upon these variables. It is further noted, that of these variables, only output of the heating assembly 30 is limited. That is, the can bodies 1 are adversely affected when the temperature is over about 220° ° C. (428° F.). Thus, in one exemplary embodiment, the heating assembly 30 also includes a blower assembly 60 structured to remove heated air the enclosed space 32 and/or a housing arrangement enclosing heating arrangement 40. The blower assembly 60 is structured to, and does, lower the amount of heat in the enclosed space 32 and/or the aforementioned housing arrangement.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A can curing oven structured to cure a coating on a surface of a sidewall of a number of can bodies, the can curing oven comprising:
a heating assembly including a number of induction heating units sized and configured to define a space generally enclosed by the number of induction heating units, the number of induction heating units structured to generate a total effective amount of received heat needed to cure the coating on each can body; and
a conveyance arrangement structured to support and move a number of can bodies along a workpath through the generally enclosed space.

2. The can curing oven of claim 1, wherein:
each induction heating unit comprises:
a heating element; and
an induction coil positioned around the heating element, the induction coil structured to be coupled to a controlled source of AC power.

3. The can curing oven of claim 2, wherein the heating element comprises a length of c-channel.

4. The can curing oven of claim 1, wherein:
the number of induction heating units includes a plurality of induction heating units; and
at least two induction heating units of the plurality of induction heating units are disposed on opposing sides of the workpath.

5. The can curing oven of claim 1, wherein:
the number of induction heating units includes a plurality of induction heating units; and
at least two induction heating units of the plurality of induction heating units are disposed on a single side of the workpath.

6. The can curing oven of claim 1, further comprising a housing generally enclosing the heating assembly.

7. The can curing oven of claim 1, wherein the can curing oven is structured to cure a coating of a can body in a first configuration and a can body in a second configuration wherein a can body of the first configuration is different than a can body of the second configuration, and wherein:
the housing assembly includes an adjustable mounting assembly; and
the adjustable mounting assembly is structured to position each induction heating unit in:
a first position, wherein each induction heating unit is structured to generate a proportional effective amount of received heat for a can body of a first configuration, and
a second position, wherein each induction heating unit is structured to generate a proportional effective amount of received heat for a can body of a second configuration.

8. The can curing oven of claim 1, wherein each induction heating unit is a modular induction heating unit.

9. The can curing oven of claim 2, wherein each induction coil is structured to be selectively powered by the controlled source of AC power when the outer surface of the can body is an effective distance away.

10. The can curing oven of claim 1, wherein:
the conveyance arrangement includes a plurality of support elements; and
each support element of the plurality of support elements is structured to be coupled to and support a can body of the number of can bodies.

11. The can curing oven of claim 1, wherein at least one induction heating unit of the number of induction heating units is positioned between two different portions of the workpath or between a portion of the workpath and a portion of another workpath along which the conveyance arrangement and/or another conveyance arrangement is structured to move can bodies of the number of can bodies.

12. The can curing oven of claim 1, wherein the number of heating units are structured to process can bodies at a maximum can decorator speed.

13. The can curing oven of claim 1, wherein the conveyance arrangement is structured to support and move the number of can bodies along a linear workpath through the generally enclosed space.

14. The can curing oven of claim 1, wherein the conveyance arrangement is structured to support and move the number of can bodies along a non-linear workpath through the generally enclosed space.

15. A method of curing a coating on an outer surface of a sidewall of each can of a number of can bodies, the method comprising:
providing the number of can bodies adjacent a number of induction heating units, and
powering the number of induction heating units to generate a total effective amount of received heat needed to cure the coating on the outer surface of the sidewall of each can body of the number of can bodies.

16. The method of claim 15, wherein:
each induction heating unit comprises:
a heating element; and
an induction coil positioned around the heating element; and
powering the number of induction heating units comprises selectively providing AC power to the induction coil of each induction heating unit.

17. The method of claim 15, wherein powering the number of induction heating units to generate the total effective amount of received heat comprises:
powering the number of induction heating units from an unpowered state when the outer surface of a can body of the number of can bodies is an effective distance away from an induction heating unit of the number of induction heating units.

18. The method of claim 15, wherein providing the number of can bodies adjacent the number of induction heating units comprises providing a plurality of can bodies adjacent the number of induction heating units via a conveyance arrangement.

19. The method of claim 18, wherein powering the number of induction heating units to generate the total effective amount of received heat comprises:
powering the number of induction heating units from an unpowered state when the outer surface of a can body of the number of can bodies is an effective distance away from an induction heating unit of the number of induction heating units, and
returning the number of induction heating units to the unpowered state upon the outer surface of another can body of the number of can bodies moving from an effective distance away from an induction heating unit of the number of induction heating units.

20. The method of claim 15, wherein providing the number of can bodies adjacent the number of induction heating units comprises providing the number of can bodies along a linear workpath adjacent the number of induction heating units.
